(19) United States
(12) Patent Application Publication
(10) Pub. No.: US 2008/0211744 A1
(43) Pub. Date: Sep. 4, 2008

(54) Organic light emitting display and driving circuit thereof

(76) Inventor: Hyunjung Lee, Yongin-si (KR)

Correspondence Address: LEE & MORSE, P.C., 3141 FAIRVIEW PARK DRIVE, SUITE 500, FALLS CHURCH, VA, 22042, US

(21) Appl. No.: 12/000,617

(22) Filed: Dec. 14, 2007

(30) Foreign Application Priority Data
Mar. 2, 2007 (KR) 10-2007-0020735

(51) Int. Cl. G09G 3/30

(52) U.S. Cl. 345/76; 315/169.3

(57) ABSTRACT

An organic light emitting display includes a first light emitting control driver electrically coupled to a clock line, a negative clock line, and an initial driving line, and adapted to output a first light emitting control signal via a first light emitting control line, a first pixel unit electrically coupled to the first light emitting control line, a second pixel unit electrically coupled to the first light emitting control line; and a third pixel unit electrically coupled to the first light emitting control line.

### CROSS REFERENCE TO RELATED APPLICATION

Cross reference is made to concurrently filed U.S. patent application Ser. No. ______ (Attorney Docket No. 303/030) and titled “Organic Light Emitting Display and Driving Circuit Thereof.”

### BACKGROUND OF THE INVENTION

1. Field of the Invention

Embodiments of the present invention relate to a light emitting display, e.g., an organic light emitting display, and a driving circuit thereof. More particularly, embodiments of the invention relate to light emitting displays and driving circuits thereof in which a single light emitting control driving line is electrically coupled to multiple, e.g., three, rows of pixels of a display and is capable of respectively supplying a light emitting control signal to the multiple, e.g., three, rows of pixels during a same driving period in order to reduce a number of driving circuits, reduce manufacturing cost, and improve yield.

2. Description of the Related Art

In general, an organic light emitting display is a display device that is capable of electrically exciting a light emitting material, e.g., a fluorescent or phosphorescent organic compound, to emit light and display an image by driving N×M organic light emitting diodes (OLEDs). An OLED may include an anode, e.g., indium tin oxide (ITO), an organic thin film, and a cathode, e.g., metal. The organic thin film may include multi-layers, e.g., an emitting layer (EML) in which light is emitted when electrons are combined with holes, an electron transport layer (ETL) in which the electrons are transported, and a hole transport layer (HTL) in which the holes are transported. The organic thin film may further include an electron injecting layer (EIL) in which additional electrons are injected and a hole injecting layer (HIL) in which holes are injected.

Such OLEDs may be driven using a passive matrix method and/or an active matrix method in which an MOS (metal oxide silicon) thin film transistor (TFT) may be used. In the passive matrix method, an anode and a cathode, which extend perpendicular to each other, may be used to select and drive a line. In the active matrix method, each of the thin film transistors and a capacitor is connected to an ITO pixel electrode to store a voltage using the capacitance of the capacitor.

Such organic light emitting displays may be used as a display device for a variety of devices, e.g., a personal computer, a mobile phone, a portable information terminal, such as a PDA, or a display device for a plurality of information equipment.

A plurality of light emitting display devices that have a relatively lighter-weight and smaller size than cathode ray tube displays have been developed. For example, organic light emitting displays have been developed. The organic light emitting displays also have relatively excellent luminous efficiency, brightness, wide-viewing angle, and fast response speed.

However, as the resolution of the organic light emitting displays increases, the size of a driving unit used to drive the pixels thereof becomes large. To help reduce the size of the organic light emitting display, a dead space is used for the driving unit thereof. However, the amount of dead space of a real product, e.g., an organic light emitting display, is limited. If the size of the driving unit for driving the relatively higher-resolution organic light emitting display becomes larger than the size of the limited dead space, the size of the organic light emitting display increases. Accordingly, there is a problem in that the size of the organic light emitting display may be increased as a result of, e.g., the relatively large size of the driving unit.

Further, many light emitting control driving circuits include both an PMOS transistor(s) and an NMOS transistor(s). Such light emitting control drivers thus require an additional processing step(s) and/or substrate. Accordingly, there is a problem in that the organic light emitting display may become relatively large and heavy, and the processing thereof may become complicated.

### SUMMARY OF THE INVENTION

The present invention is therefore directed to provide a light emitting display and a driving circuit thereof that substantially overcome one or more of the problems due to the limitations and disadvantages of the related art.

It is therefore a feature of an embodiment of the present invention to provide a light emitting display, e.g., an organic light emitting display, and a driving circuit thereof in which one light emitting control driving line is electrically coupled to a plurality of, e.g., three, rows of pixels such that a same/single light emitting control signal may be supplied to the respective plurality of, e.g., three, rows of pixels associated therewith during a same driving period, i.e., may be simultaneously and/or substantially simultaneously supplied to the respective plurality of, e.g., three, rows of pixels associated therewith.

It is therefore a separate feature of an embodiment of the present invention to provide a light emitting control driver and a light emitting display, e.g., an organic light emitting display, including such a light emitting control driver that is electrically coupled to a plurality of, e.g., three, rows of pixels and is adapted to simultaneously and/or substantially simultaneously supply a light emitting control signal to the respective plurality of, e.g., three, rows of pixels such that an area of the driving circuit and/or a manufacturing cost may be reduced, and a manufacturing yield thereof may be increased. That is, the light emitting control driver may respectively supply a same single light emitting control signal to each of the plurality of rows of pixels during a same driving period.

It is therefore a separate feature of an embodiment of the present invention to provide a light emitting control driver including only transistors of a same transistor-type that are included in pixels of a light emitting display.

It is therefore a separate feature of an embodiment of the present invention to provide a light emitting control driver and/or a light emitting display, e.g., an organic light emitting display, including such a light emitting control driver having a relatively lower manufacturing cost, a relatively shorter manufacturing time, and/or an improved manufacturing yield.

At least one of the above and other features and advantages of the present invention may be realized by providing an organic light emitting display, including a first light emitting control driver electrically coupled to a clock line, a negative clock line, and an initial driving line, and adapted to output a first light emitting control signal via a first light emitting control line, a first pixel unit electrically coupled to the first light emitting control line, a second pixel unit electrically coupled to the first light emitting control line, and a third pixel unit electrically coupled to the first light emitting control line.

The light emitting display may include a panel including first to m-th data lines, wherein the first pixel unit may include first row pixels electrically coupled to a first scan driving line and the first to m-th data lines, the second pixel unit includes second row pixels electrically coupled to a second scan driving line and the first to m-th data lines, and the third pixel unit includes third row pixels electrically coupled to a third scan driving line and the first to m-th data lines.

Each of the first to third pixel units may respectively receive the first light emitting control signal to emit light simultaneously. The first light emitting control driver may include a first clock terminal electrically coupled to the clock line, a second clock terminal electrically coupled to the negative clock line, an input terminal electrically coupled to the initial driving line, an output terminal electrically coupled to the first light emitting control line and adapted to output to first light emitting control signal, and a negative output terminal electrically coupled to a first negative light emitting control line and adapted to output a first negative light emitting control signal. The light emitting display may include a second light emitting control driver including an input terminal, wherein the output terminal of the first light emitting control driver is electrically coupled to the input terminal of the second light emitting control driver.

The first light emitting control driver may include a first switching element electrically coupled between the initial driving line and a first power voltage line, a second switching element including a control electrode electrically coupled to the clock line and being electrically coupled between the first switching element and the first power voltage line, a third switching element including a control electrode electrically coupled between the first switching element and the second switching element and being electrically coupled between the second switching element and the negative clock line, a fourth switching element including a control electrode electrically coupled between the second switching element and the third switching element and being electrically coupled between the first power voltage line and a second power voltage line, a fifth switching element including a control electrode electrically coupled to the clock line and being electrically coupled between the fourth switching element and the second power voltage line, a sixth switching element including a control electrode electrically coupled between the fourth switching element and the fifth switching element and being electrically coupled between the first power voltage line and the second power voltage line, a seventh switching element including a control electrode electrically coupled between the second switching element and the third switching element and being electrically coupled between the sixth switching element and the second power voltage line, an eighth switching element including a control electrode electrically coupled between the sixth switching element and the seventh switching element and being electrically coupled between the first power voltage line and the second power voltage line, and a ninth switching element including a control electrode electrically coupled between the fourth switching element and the fifth switching element and being electrically coupled between the eighth switching element and the second power voltage line.

The first switching element may include a control electrode electrically coupled to the clock line, a first electrode electrically coupled to the control electrode of the third switching element, and a second electrode electrically coupled to the initial driving line. The first switching element may include a control electrode electrically coupled to the initial driving line, a first electrode electrically coupled to the control electrode of the third switching element, and a second electrode electrically coupled to the initial driving line.

The second switching element may include a first electrode electrically coupled to the first power voltage line, and a second electrode electrically coupled between a first electrode of the third switching element and the control electrodes of the fourth and seventh switching elements. The third switching element may include a first electrode electrically coupled between the control electrodes of the fourth and seventh switching elements, and a second electrode electrically coupled to the negative clock line. The fourth switching element may include a first electrode electrically coupled to the first power voltage line, and a second electrode electrically coupled between a first electrode of the fifth switching element and the control electrode of the sixth switching element. The fifth switching element may include a first electrode electrically coupled between the control electrodes of the sixth and ninth switching elements, and a second electrode electrically coupled to the second power voltage line.

The sixth switching element may include a first electrode electrically coupled to the first power voltage line, and a second electrode electrically coupled between the first electrode of the seventh switching element, and the control electrode of the eighth switching element. The seventh switching element may include a first electrode electrically coupled between the control electrode of the eighth switching element and a first negative light emitting control line, and a second electrode electrically coupled to the second power voltage line. The eighth switching element may include a first electrode electrically coupled to the first power voltage line, and a second electrode electrically coupled to the first light emitting control line. The ninth switching element may include a first electrode electrically coupled to the first light emitting control line, and a second electrode electrically coupled to the second power voltage line.

The light emitting display may include a first storage capacitor including a first electrode electrically coupled to the control electrode of the third switching element and a second electrode electrically coupled between the second switching element and the third switching element. The light emitting display may include a second storage capacitor including a first electrode electrically coupled between the control electrode of the ninth switching element and the control electrode of the sixth switching element, and a second electrode electrically coupled between the eighth switching element, the ninth switching element, and the first light emitting control line.

At least one of the above and other features and advantages of the present invention may be separately realized by providing a driving circuit, including a plurality of light emitting control drivers, wherein each of the light emitting control driver may include an input terminal electrically coupled to an initial driving line or a negative light emitting control line of a previous light emitting control driver, a first clock terminal electrically coupled to a clock line, a second clock terminal electrically coupled to a negative clock line in which a phase thereof is inverted with respect to that of the clock line, an output terminal, and a negative output terminal, wherein the light emitting control driver may be adapted to receive an input signal from the input terminal, a clock signal from the first clock terminal, and a negative clock signal from the second clock terminal and to generate an output signal and a negative output signal to be respectively supplied to the output terminal and the negative output terminal.

Each of the light emitting control driver may include a first switching element electrically coupled between the input terminal and a first power voltage line, a second switching element including a control electrode electrically coupled to the first clock terminal and being electrically coupled between the first switching element and the first power voltage line, a third switching element including a control electrode electrically coupled between the first switching element and the second switching element and being electrically coupled between the second switching element and the second clock terminal, a fourth switching element including a control electrode electrically coupled between the second switching element and the third switching element and being electrically coupled between the first power voltage line and a second power voltage line, a fifth switching element including a control electrode electrically coupled to the first clock terminal and being electrically coupled between the fourth switching element and the second power voltage line, a sixth switching element having a control electrode electrically coupled between the fourth switching element and the fifth switching element and being electrically coupled between the first power voltage line and the second power voltage line, a seventh switching element including a control electrode electrically coupled between the second switching element and the third switching element and being electrically coupled between the sixth switching element and the second power voltage line, an eighth switching element including a control electrode electrically coupled between the sixth switching element and the seventh switching element and being electrically coupled between the first power voltage line and the second power voltage line, and a ninth switching element including a control electrode electrically coupled between the fourth switching element and the fifth switching element and being electrically coupled between the eighth switching element and the second power voltage line.

A first light emitting control driver of the light emitting control driver may include a first clock terminal electrically coupled to the clock line, a second clock terminal electrically coupled to the negative clock line, an input terminal electrically coupled to the initial driving line, an output terminal electrically coupled to the first light emitting control line to output a first light emitting control signal, and a negative output terminal electrically coupled to the first negative light emitting control line to output a first negative light emitting control signal.

Even-numbered ones of the plurality of light emitting control drivers may each include a first clock terminal electrically coupled to the negative clock line, a second clock terminal electrically coupled to the clock line, an input terminal electrically coupled to the negative light emitting control line of a previous light emitting control driver, an output terminal electrically coupled to an even-numbered light emitting control line to output a respective light emitting control signal, and a negative output terminal electrically coupled to an even-numbered negative light emitting control line to output a respective negative light emitting control signal.

Odd-numbered ones of the plurality of light emitting control drivers may include a first clock terminal electrically coupled to the clock line, a second clock terminal electrically coupled to the negative clock line, an input terminal electrically coupled to one of the initial driving line or the negative light emitting control line of a previous light emitting control driver, an output terminal electrically coupled to an odd-numbered light emitting control line to output a respective light emitting control signal, and a negative output terminal electrically coupled to an odd-numbered negative light emitting control line to output a respective negative light emitting control signal.

The first switching element may include a control electrode electrically coupled to the first clock terminal, a first electrode electrically coupled to the control electrode of the third switching element, and a second electrode electrically coupled to the input terminal. The first switching element may include a control electrode electrically coupled to the input terminal, a first electrode electrically coupled to the control electrode of the third switching element, and a second electrode electrically coupled to the input terminal.

The second switching element may include a first electrode electrically coupled to the first power voltage line, and a second electrode electrically coupled between a first electrode of the third switching element and the control electrode of the fourth switching element.

The third switching element may include a first electrode electrically coupled between the control electrode of the fourth switching element and the control electrode of the seventh switching element, and a second electrode electrically coupled to the second clock terminal.

The fourth switching element may include a first electrode electrically coupled to the first power voltage line, and a second electrode electrically coupled between a first electrode of the fifth switching element and the control electrode of the sixth switching element.

The fifth switching element may include a first electrode electrically coupled between the control electrode of the sixth switching element and the control electrode of the ninth switching element, and a second electrode electrically coupled to the second power voltage line.

The sixth switching element may include a first electrode electrically coupled to the first power voltage line, and a second electrode electrically coupled between the first electrode of the seventh switching element and the control electrode of the eighth switching element.

The seventh switching element may include a first electrode electrically coupled between the control electrode of the eighth switching element and a first negative light emitting control line, and a second electrode electrically coupled to the second power voltage line.

The eighth switching element may include a first electrode electrically coupled to the first power voltage line, and a second electrode electrically coupled to a first light emitting control line. The ninth switching element may include a first electrode electrically coupled to the first light emitting control line, and a second electrode electrically coupled to the second power voltage line.

The driving circuit may include a first storage capacitor including a first electrode electrically coupled to the control electrode of the third switching element and a second electrode electrically coupled between the second switching element and the third switching element.

The driving circuit may include a second storage capacitor including a first electrode electrically coupled between the control electrode of the ninth switching element and the control electrode of sixth switching element, and a second electrode electrically coupled among the eighth switching element, the ninth switching element, and the first light emitting control line. The first, second, third, fourth, fifth, sixth, seventh, eighth and ninth switching elements may be of a same transistor type. An organic light emitting display may include such a driving circuit.

### BRIEF DESCRIPTION OF THE DRAWINGS

The above and other features and advantages of embodiments of the present invention will become more apparent to those of ordinary skill in the art by describing in detail exemplary embodiments thereof with reference to the attached drawings, in which:

FIG. 1 illustrates a block diagram of an organic light emitting display according to an exemplary embodiment of the invention;

FIG. 2 illustrates a block diagram of an exemplary embodiment of a light emitting control driver employable by the organic light emitting display shown in FIG. 1;

FIG. 3 illustrates a circuit diagram of a light emitting control driving circuit employable by the light emitting control driver shown in FIG. 2;

FIG. 4 illustrates a timing diagram of exemplary signals employable for driving the light emitting control driving circuit shown in FIG. 3;

FIG. 5 illustrates a circuit diagram of an operating state of the light emitting control driving circuit shown in FIG. 3 during a first driving period;

FIG. 6 illustrates a circuit diagram of an operating state of the light emitting control driving circuit shown in FIG. 3 during a second driving period;

FIG. 7 illustrates a circuit diagram of an operating state of the light emitting control driving circuit shown in FIG. 3 during a third driving period;

FIG. 8 illustrates a circuit diagram of another exemplary embodiment of a light emitting control driving circuit employable by the light emitting control driver shown in FIG. 2;

FIG. 9 illustrates a timing diagram of exemplary signals employable for driving the light emitting control driving circuit shown in FIG. 8; and

FIG. 10 illustrates a timing diagram of exemplary signals employable for driving the light emitting control driver shown in FIG. 2.

### DETAILED DESCRIPTION OF THE INVENTION

Korean Patent Application No. 10-2007-0020735, filed on Mar. 2, 2007, in the Korean Intellectual Property Office, and entitled: “Organic Light Emitting Display and Driving Circuit Thereof,” is incorporated by reference herein in its entirety.

Aspects of the present invention will now be described more fully hereinafter with reference to the accompanying drawings, in which exemplary embodiments of the invention are illustrated. Aspects of the invention may, however, be embodied in different forms and should not be construed as limited to the embodiments set forth herein. Rather, these embodiments are provided so that this disclosure will be thorough and complete, and will fully convey the scope of the invention to those skilled in the art.

Throughout the specification, like reference numerals refer to like elements having similar structures or operations throughout the specification. Further, it will be understood that when one part is described as being electrically coupled to another part, the two parts may be directly connected to each other or may be indirectly connected via other elements positioned or connected therebetween.

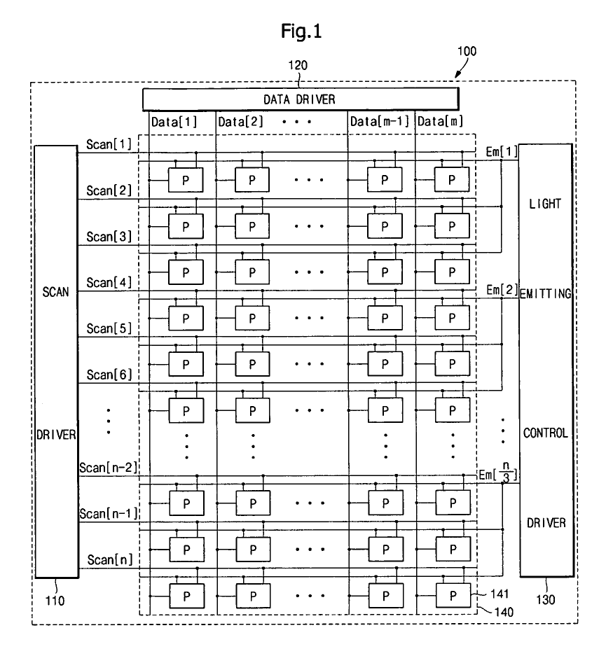

FIG. 1 illustrates a block diagram of an organic light emitting display 100 according to an exemplary embodiment of the invention.

As shown in FIG. 1, the organic light emitting display 100 may include a scan driver 110, a data driver 120, a light emitting control driver 130, and an organic light emitting display panel (hereinafter, referred to as panel 140).

The panel 140 may include a plurality of scan lines (Scan[1], Scan[2], . . . , Scan[n]) and a plurality of light emitting control lines (Em[1], Em[2], . . . , Em[n/3]) arranged in a row direction, a plurality of data lines (Data[1], Data[2], . . . , Data[m]) arranged in a column direction, and a plurality of pixels 141 defined by the plurality of scan lines (Scan[1], Scan[2], . . . , Scan[n]), the plurality of data lines (Data[1], Data[2], . . . , Data[m]), and the plurality of light emitting control lines (Em[1], Em[2], . . . , Em[n/3]).

The pixels 141 may be formed in pixel regions defined by respective ones of two adjacent scan lines (Scan[1], Scan[2], . . . , Scan[n]) and two adjacent ones of the data lines (Data[1], Data[2], . . . , Data[m]).

The scan driver 110 may sequentially supply respective scan signals to the panel 140 through the plurality of scan lines (Scan[1], Scan[2], . . . , Scan[n]).

The data driver 120 may sequentially supply respective data signals to the panel 140 through the plurality of data lines (Data[1], Data[2], . . . , Data[m]).

The light emitting control driver 130 may sequentially supply light emitting control signals to the panel 140 through the plurality of light emitting control lines (Em[1], Em[2], . . . , Em[n/3]). The plurality of pixels 141 may be connected to the light emitting control lines (Em[1], Em[2], . . . , Em[n/3]) and may receive the respective light emitting control signals to determine a point of time at which current generated in respective ones of the pixels 141 flows to respective light emitting diode thereof. The pixels 141 may be electrically coupled between the light emitting control lines (Em[1], Em[2], . . . , Em[n/3]) and the scan lines (Scan[1], Scan[2], . . . , Scan[n]). Each of the light emitting control lines (Em[1], Em[2], . . . , Em[n/3]) may be electrically coupled to a plurality of, e.g., three, rows of pixels to simultaneously transfer the respective light emitting signal to the corresponding pixels 141 in the plurality of, e.g., three, rows of pixels associated therewith.

In the description of exemplary embodiments herein, each of the light emitting control lines (Em[1], Em[2], . . . , Em[n/3]) will be described as being connected to three rows of the pixels. Further, in the following description of exemplary embodiments a predetermined group, e.g., a row, of the pixels 141 may be referred to as a pixel unit. However, embodiments of the invention are not limited thereto.

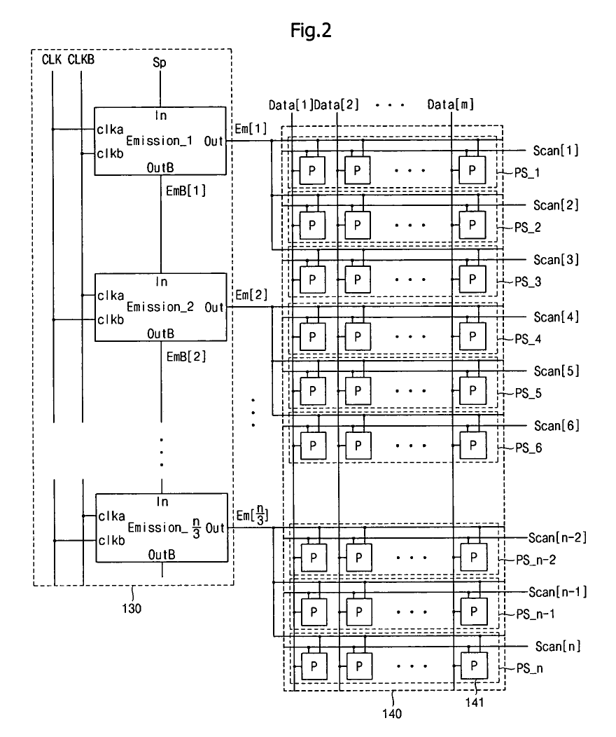

In some embodiments of the invention, e.g., a first light emitting control line (Em[1]) may be electrically coupled to the pixels 141 of first, second and third pixel units PS_1, PS_2, PS_3 (see FIG. 2) that may be electrically coupled to the first to third scan lines (Scan[1], Scan[2], and Scan[3]) to simultaneously transfer the first light emitting control signal to the pixels 141 of the first to third pixel units PS_1, PS_2, PS_3. By electrically coupling each of the light emitting control lines (Em[1], Em[2], . . . , Em[n/3]) to three of the scan lines (Scan[1], Scan[2], . . . , Scan[n]), the size of the light emitting control driver 130 according to embodiments of the invention may be reduced to, e.g., one-third of a light emitting control driver having, e.g., a separately driven light emitting control line electrically coupled to each of the scan lines, i.e., a separate light emitting control driving unit for each of the light emitting control lines and each of the scan lines.

Further, the light emitting control driver 130 according to embodiments of the invention may be implemented using transistors of only a same kind as transistors of the pixels 141 such that the light emitting control driver 130 may be formed on a same substrate without additional processing when forming the panel 140 of the light emitting display. Therefore, embodiments of the invention may enable the light emitting control driver 130 to be formed on the same substrate as the pixels 141 without requiring additional processing and/or an additional chip.

FIG. 2 illustrates a block diagram of an exemplary embodiment of the light emitting control driver 130 employable by the organic light emitting display shown in FIG. 1. As shown in FIG. 2, the light emitting control driver 130 may include first to n/3-th light emitting control driving units (Emission_1 to Emission_n/3). The first to n/3-th light emitting control driving units (Emission_1 to Emission_n/3) may be electrically coupled to first to n-th pixel units (PS_1 to PS_n) to supply the respective light emitting control signals to the first to n-th pixel units (PS_1, PS_2, . . . ,PS_n). More particularly, in embodiments of the invention, each of the n pixel units (PS_1, PS_2, . . . ,PS_n) may be electrically coupled to a respective one of the n/3 light emitting control driving units (Emission_1, Emission_2, . . . ,Emission_n/3), where n may be any positive integer.

The first light emitting control driving unit (Emission_1) may include a first clock terminal (clka) that may be electrically coupled to a clock line (CLK), a second clock terminal (clkb) that may be electrically coupled to a negative clock line (CLKB), an input terminal (In) that may be electrically coupled to an initial driving line (Sp) and may receive an initial driving signal, an output terminal (Out) that may be electrically coupled to the first light emitting control line (Em[1]) and may output a first light emitting control signal thereto. Further, the first light emitting control driving unit (Emission_1) may include a negative output terminal (OutB) that may be electrically coupled to a first negative light emitting control line (EmB[1]) and may output a first negative light emitting control signal thereto. The first light emitting control driving unit (Emission_1) may be electrically coupled to the first pixel unit (PS_1), the second pixel unit (PS_2) and the third pixel unit (PS_3), and may supply the first light emitting control signal to the first, second and third pixel units (PS_1, PS_2, and PS_3). Thus, the first light emitting control line (Em[1]) may be electrically coupled to the three pixel units (PS_1, PS_2, and PS_3) to simultaneously supply the first light emitting control signal to the three pixel units (PS_1, PS_2 and PS_3).

In the second light emitting control driving unit (Emission_2), a first clock terminal (clka) may be electrically coupled to the negative clock line (CLKB) and a second clock terminal (clkb) may be electrically coupled to the clock line (CLK). Further, an input terminal (In) may be electrically coupled to the first negative light emitting control line (EmB[1]) such that the second light emitting control driving unit (Emission_2) may receive the first negative light emitting control signal from the first light emitting control driving unit (Emission_1). The second light emitting control driving unit (Emission_2) may include an output terminal (Out) electrically coupled to the second light emitting control line (Em[2]), and may output a second light emitting control signal thereto. Further, the second light emitting control driving unit (Emission_2) may include a negative output terminal (OutB) electrically coupled to a second negative light emitting control line (EmB[2]), and may output a second negative light emitting control signal thereto. In some embodiments of the invention, the second light emitting control driving unit (Emission_2) may be electrically coupled to the fourth pixel unit (PS_4), the fifth pixel unit (PS_5) and the sixth pixel unit (PS_6), and may supply the second light emitting control signal to the fourth, fifth and sixth pixel units (PS_4, PS_5 and PS_6). Thus, the one second light emitting control line (Em[2]) may be electrically coupled to the three pixel units (PS_4 to PS_6) to simultaneously supply the second light emitting control signal to the respective three pixel units (PS_4, PS_5 and PS_6) associated therewith, i.e., to respectively supply the second light emitting control signal to the fourth, fifth and sixth pixels units (PS_4, PS_5 and PS_6) during a same driving period.

In some embodiments of the invention, the light emitting control driving units (Emission_1 to Emission_n/3) may be coupled with the pixel units (PS_1 to PS_n) in a pattern following the coupling scheme described above with regard to the first and second light emitting control driving units (Emission_1 and Emission_2).

More particularly, e.g., in some embodiments of the invention, in odd-numbered light emitting control driving units (Emission_1, Emission_3, Emission_5, etc.), a first clock terminal (clka) may be electrically coupled to the clock line (CLK) and a second clock terminal (clkb) may be electrically coupled to the negative clock line (CLKB). Further, an input terminal (In) thereof may be electrically coupled to a previously driven negative light emitting control line in order to receive a previous negative light emitting signal output from the previously driven light emitting control driving unit (e.g., the third light emitting control driving unit (Emission_3) may receive the second negative light emitting control signal output from the second light emitting control driving unit (Emission_2) via the second negative light emitting control line (EmB[2])).

Further, in general, the odd-numbered light emitting control driving units (Emission_1, Emission_3, Emission_5, etc.) may include an output terminal (Out) electrically coupled to the respective light emitting control line (Em[1], Em[3], Em[5], etc.), and may output the respective light emitting control signal thereto. The odd-numbered light emitting control driving units (Emission_1, Emission_3, Emission_5, etc.) may further include a negative output terminal (OutB) electrically coupled to the respective negative light emitting control line (EmB[1], Em B[3], EmB[5], etc.), and may output the respective negative light emitting control signal generated thereby thereto. For example, in the case of the third light emitting control driving unit (Emission_3), the previous negative light emitting control line may correspond to the second negative light emitting control line (EmB[2]) such that the third light emitting control driving unit (Emission_3) may receive the second negative light emitting control signal at the input terminal (In) thereof and the third light emitting control driving unit (Emission_3) may output a third negative light emitting control signal to the third negative light emitting control line (EmB[3]).

In some embodiments of the invention, in even-numbered light emitting control driving units (Emission_2, Emission_4, Emission_6, etc.), a first clock terminal (clka) may be electrically coupled to the negative clock line (CLKB) and a second clock terminal (clkb) may be electrically coupled to the clock line (CLK). Further, an input terminal (In) thereof may be electrically coupled to a previously driven negative light emitting control line in order to receive a previous negative light emitting signal output from the previously driven light emitting control driving unit (e.g., the fourth light emitting control driving unit (Emission_4) may receive the third negative light emitting control signal from the third light emitting control driving unit (Emission_3) via the third negative light emitting control line (EmB[3])).

Further, in general, the even-numbered light emitting control driving units (Emission_2, Emission_4, Emission_6, etc.) may include an output terminal (Out) electrically coupled to the respective light emitting control line (Em[2], Em[4], etc.), and may output the respective light emitting control signal thereto. The even-numbered light emitting control driving units (Emission_2, Emission_4, Emission_6, etc.) may further include a negative output terminal (OutB) electrically coupled to the respective negative light emitting control line, and may output the respective negative light emitting control signal generated thereby thereto. For example, in the case of the fourth light emitting control driving unit (Emission_4), the previous negative light emitting control line may correspond to the third negative light emitting control line (EmB[3]) such that the fourth light emitting control driving unit (Emission_4) may receive the third negative light emitting control signal at the input terminal (In) thereof and the fourth light emitting control driving unit (Emission_4) may output a fourth negative light emitting control signal to the fourth negative light emitting control line (EmB[4]).

Further, in embodiments of the invention, each of the odd-numbered light emitting control driving units (Emission_1, Emission_3, Emission_5, etc.) and each of the even-numbered light emitting control driving units (Emission_2, Emission_4, Emission_6, etc.) may be electrically coupled to three respective ones of the pixel units (PS_1, PS_2, . . . PS_n) to supply the light emitting control signal to the three pixel units associated therewith. That is, a single light emitting control line may be electrically coupled to three of the pixel units (PS_1, PS_2, . . . PS_n) to simultaneously supply a single light emitting control signal to the corresponding three pixel units. Therefore, the size of the light emitting control driver 130 according to embodiments of the invention may be reduced to, e.g., one-third of a light emitting control driver having, e.g., a separately driven light emitting control line coupled to each of the scan lines (Scan[1], Scan[2], and Scan[3]), i.e., a separate light emitting control driving unit for each of the scan lines (Scan[1], Scan[2], and Scan[3]).

In some embodiments of the invention, the light emitting control driving units (Emission_1 to Emission n/3) may be coupled with the pixel units (PS_1 to PS_n) in a pattern following the coupling scheme described above with regard to the first, second and third light emitting control driving units (Emission_1, Emission_2, and Emission_3).

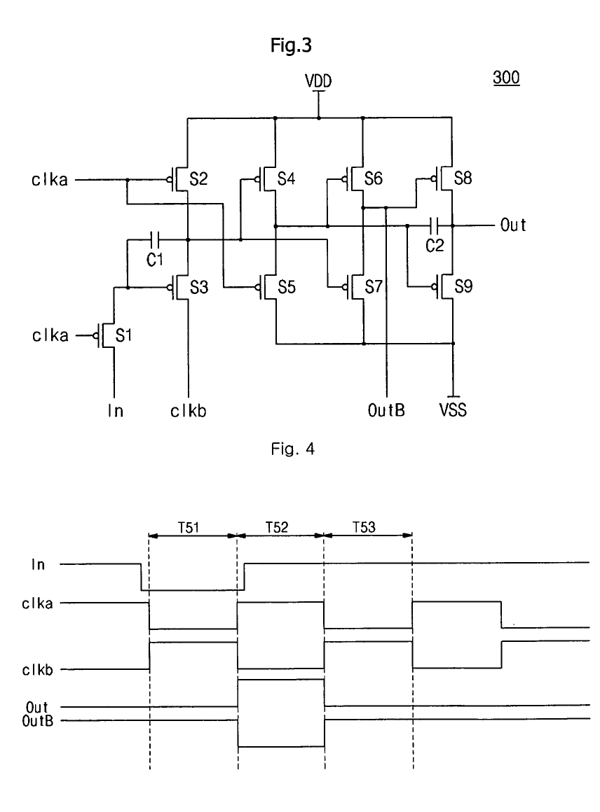

FIG. 3 illustrates a circuit diagram of a light emitting control driving circuit 300 employable by the light emitting control driver 130 shown in FIG. 2.

More particularly, in some embodiments of the invention, the light emitting control driving circuit 300 may be employed by each of the light emitting control driving units (Emission_1, Emission_2, Emission_n/3). As shown in FIG. 3, the light emitting control driving circuit 300 may include a first switching element (S1), a second switching element (S2), a third switching element (S3), a fourth switching element (S4), a fifth switching element (S5), a sixth switching element (S6), a seventh switching element (S7), an eighth switching element (S8), a ninth switching element (S9), a first storage capacitor (C1), and a second storage capacitor (C2).

The first switching element (S1) may include a first electrode (drain electrode or source electrode) electrically coupled to a control electrode of the third switching element (S3), a second electrode (source electrode or drain electrode) electrically coupled to the input terminal (In) of the respective light emitting control driving unit (Emission_1), and a control electrode (gate electrode) electrically coupled to the first clock terminal (clka). Accordingly, when a clock signal at a low level is supplied to the control electrode of the first switching element (S1), the first switching element (S1) is turned on to supply a signal supplied from the input terminal (In) to the control electrode of the third switching element (S3).

The second switching element (S2) may include a first electrode electrically coupled to a first power supply line (VDD), a second electrode electrically coupled between a first electrode of the third switching element (S3), a control electrode of the fourth switching element (S4), and a control electrode of the seventh switching element (S7), and a control electrode electrically coupled to the first clock terminal (clka). Accordingly, when a clock signal at a low level is supplied to the control electrode of the second switching unit (S2), the second switching element (S2) is turned on to supply a first power voltage applied from the first power supply line (VDD) to the control electrode of the fourth switching element (S4) and the control electrode of the seventh switching element (S7).

The third switching element (S3) may include a first electrode electrically coupled between the control electrode of the fourth switching element (S4) and the control electrode of the seventh switching element (S7), a second electrode electrically coupled to the second clock terminal (clkb), and a control electrode electrically coupled to the first electrode of the first switching element (S1). When an input signal at a low level transferred from the first switching element (S1) is supplied to the control electrode thereof, the third switching element (S3) is turned on to supply a clock signal supplied from the second clock terminal (clkb) to the control electrode of the fourth switching element (S4) and the control electrode of the seventh switching element (S7).

The fourth switching element (S4) may include a first electrode electrically coupled to the first power supply line (VDD), a second electrode electrically coupled between a first electrode of the fifth switching element (S5), a control electrode of the sixth switching element (S6), and a control electrode of the ninth switching element (S9), and a control electrode electrically coupled between the second switching element (S2) and the third switching element (S3). When a clock signal at a low level transferred from the third switching element (S3) is supplied to the control electrode thereof, the fourth switching element (S4) is turned on to apply the first power voltage applied from the first power supply line (VDD) to the control electrode of the sixth switching element (S6) and the control electrode of the ninth switching element (S9).

The fifth switching element (S5) may include a first electrode electrically coupled between the control electrode of the sixth switching element (S6) and the control electrode of the ninth switching element (S9), a second electrode electrically coupled to a second power supply line (VSS), and a control electrode electrically coupled to the first clock terminal (clka). When a clock signal at a low level is supplied to the control electrode, the fifth switching element (S5) is turned on to apply a second power voltage applied from the second power supply line (VSS) to the control electrode of the sixth switching element (S6) and the control electrode of the ninth switching element (S9).

The sixth switching element (S6) may include a first electrode electrically coupled to the first power supply line (VDD), a second electrode electrically coupled between a first electrode of the seventh switching element (S7), a control electrode of the eighth switching element (S8) and the negative output terminal (OutB) of the respective light emitting control driving unit, e.g., (Emission_1), and a control electrode electrically coupled between the fourth switching element (S4) and the fifth switching element (S5). When a second power voltage transferred from the fifth switching element (S5) is applied to the control electrode of the sixth switching element (S6), the sixth switching element (S6) is turned on to output the first power voltage applied from the first power supply line (VDD) to the control electrode of the eighth switching element (S8) and the negative output terminal (OutB).

The seventh switching element (S7) may include a first electrode electrically coupled between the control electrode of the eighth switching element (S8) and the negative output terminal (OutB) of the respective light emitting control driving unit, e.g., (Emission_1), a second electrode electrically coupled to the second power supply line (VSS), and a control electrode electrically coupled between the second switching element (S2) and the third switching element (S3). When a clock signal at a low level is supplied to the control electrode thereof, the seventh switching element (S7) is turned on to output the second power voltage supplied from the second power supply line (VSS) to the control electrode of the eighth switching element (S8) and the negative output terminal (OutB).

The eighth switching element (S8) may include a first electrode electrically coupled to the first power supply line (VDD), a second electrode electrically coupled between a first electrode of the ninth switching element (S9) and the output terminal (Out) of the respective light emitting control driving unit, e.g., (Emission_1), and a control electrode electrically coupled between the sixth switching element (S6) and the seventh switching element (S7). When the second power voltage transferred from the seventh switching element (S7) is applied to the control electrode thereof, the eighth switching element (S8) is turned on to output the first power voltage supplied from the first power supply line (VDD) to the output terminal (Out).

The ninth switching element (S9) may include a first electrode electrically coupled to the output terminal (Out), a second electrode electrically coupled to the second power supply line (VSS), and a control electrode electrically coupled between the fourth switching element (S4) and the fifth switching element (S5). When the second power voltage supplied from the fifth switching element (S5) is applied to the control electrode thereof, the ninth switching element (S9) is turned on to output the second power voltage supplied from the second power supply line (VSS) to the output terminal (Out).

The first storage capacitor (C1) may include a first electrode electrically coupled between the first electrode of the first switching element (S1) and the control electrode of the third switching element (S3) and a second electrode electrically coupled between the second switching element (S2) and the third switching element (S3). The first storage capacitor (C1) may store a voltage difference between the first electrode and the control electrode of the third switching element (S3).

The second storage capacitor (C2) may include a first electrode electrically coupled to the control electrode of the ninth switching element (S9) and a second electrode electrically coupled among the eighth switching element (S8), the ninth switching element (S9), and the output terminal (Out) of the respective light emitting control driving unit, e.g., (Emission_1). The second storage capacitor (C2) may store a voltage difference between the first electrode and the control electrode of the ninth switching element (S9).

As shown in FIG. 3, all of the switching elements, e.g., S1, S2, S3, S4, S5, S6, S7, S8 and S9, of the light emitting control driving circuits 300 of the light emitting control driving units (Emission_1 to Emission_n/3) may be of a same type, e.g., p-type transistors such as PMOS transistors. However, embodiments of the invention are not limited thereto as, e.g., all of the switching elements, e.g., S1 to S9, may be, e.g., n-type transistors.

If the pixels 141 of the organic light emitting display include transistors of only a same type as transistors of the light emitting control driving circuits, it is possible to simplify the process of forming the organic light emitting display as the light emitting control driving circuits may be formed on a same substrate as the pixels 141 of the display without requiring additional processing. Further, if the light emitting control driving circuits 300 and the pixels 141 are formed on the same substrate, it is possible to reduce the size, weight, and cost of the organic light emitting display. Accordingly, in some embodiments in which the pixels 141 include, e.g., only p-type transistors, i.e., no n-type transistors, by structuring the light emitting control driving circuit 300 shown in FIG. 3 to include transistors of only p-type, e.g., PMOS transistors, as the first through ninth switching elements (S1 to S9), it is possible to simplify the process of forming the light emitting control driving circuits 300 and the pixels 141 and to form them on a same substrate without requiring additional processing.

FIG. 4 illustrates a timing diagram of exemplary signals employable for driving the light emitting control driving circuit 300 shown in FIG. 3.

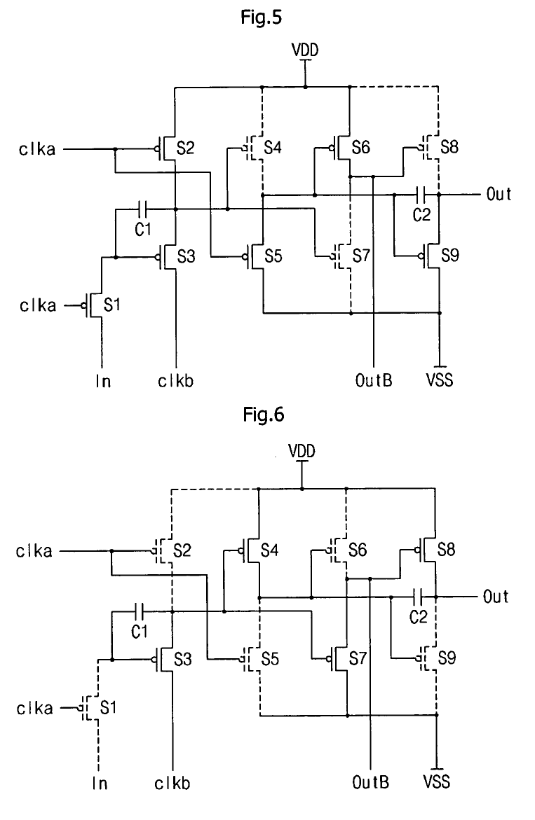

As shown in FIG. 4, the timing diagram of the light emitting control driving circuit 300 shown in FIG. 3 may include a first driving period (T51), a second driving period (T52) and a third driving period (T53). Operation of the light emitting control driving circuit 300 will be described below with reference to FIGS. 5, 6 and 7 illustrating respective operating states of the light emitting control driving circuit 300.

More particularly, FIG. 5 illustrates a circuit diagram of an operating state of the light emitting control driving circuit 300 shown in FIG. 3 during the first driving period (T51).

During the first driving period (T51), when a clock signal at a low level is supplied to the first clock terminal (clka), the first switching element (S1), the second switching element (S2), and the fifth switching element (S5) are turned on. More particularly, the first switching element (S1) is turned on to supply an input signal at a low level supplied from the input terminal (In) to the control electrode of the third switching element (S3). When the third switching element (S3) receives the input signal at the low level, the third switching element (S3) is turned on and supplies a clock signal at a high level supplied from a second clock terminal (clkb) to the control electrode of the fourth switching element (S4) and the control electrode of the seventh switching element (S7).

During the first driving period (T51), the second switching element (S2) is also turned on and applies the first power voltage of the first power supply line (VDD) to the control electrode of the fourth switching element (S4) and the control electrode of the seventh switching element (S7). As a result, the fourth switching element (S4) and the seventh switching element (S7) receiving the clock signal at the high level and the first power voltage of a high level are turned off. Accordingly, the first storage capacitor (C1) coupled between the first electrode and the control electrode of the third switching element (S3) may store a voltage corresponding to a voltage difference between the first power voltage received from the second switching element (S2) and the input signal received from the first switching element (S1).

Further, during the first driving period (T51), the fifth switching element (S5) is turned on and applies the second power voltage of the second power supply line (VSS) to the control electrode of the sixth switching element (S6) and the control electrode of the ninth switching element (S9) such that the sixth switching element (S6) and the ninth switching element (S9) are turned on. When the sixth switching element (S6) is turned on, the sixth switching element (S6) applies the first power voltage of the first power supply line (VDD) to the control electrode of the eighth switching element (S8) and the negative output terminal (OutB) such that the eighth switching element (S8) is turned off and the first power voltage is output through the negative output terminal (OutB). Further, the ninth switching element (S9) is turned on and outputs the second power voltage of the second power supply line (VSS) to the output terminal (Out). As a result, the second storage capacitor (C2) may store a voltage corresponding to the voltage difference between the second power voltage received from the fifth switching element (S5) and the second power voltage received from the ninth switching element (S9). The voltage stored in the second storage capacitor (C2) may be used to compensate for voltage lost in the driving circuit 300 when the second power voltage is output.

FIG. 6 illustrates a circuit diagram of an operating state of the light emitting control driving circuit 300 shown in FIG. 3 during the second driving period (T52).

During the second driving period (T52), when a clock signal at a high level is supplied to the first clock terminal (clka), the first switching element (S1), the second switching element (S2), and the fifth switching element (S5) are turned off. At this time, the third switching element (S3) is turned on by the voltage stored in the first storage capacitor (C1) during the first driving period (T51) and supplies the clock signal at a low level supplied from the second clock terminal (clkb) to the control electrode of the fourth switching element (S4) and the control electrode of the seventh switching element (S7). The fourth switching element (S4) and the seventh switching element (S7) are turned on by receiving the clock signal at the low level. The fourth switching element (S4) is turned on and applies the first power voltage of the first power supply line (VDD) to the control electrode of the sixth switching element (S6) and the control electrode of the ninth switching element (S9) such that the sixth switching element (S6) and the ninth switching element (S9) are turned off.

Further, during the second driving period (T52), the seventh switching element (S7) is turned on and applies the second power voltage of the second power supply line (VSS) to the control electrode of the eighth switching element (S8) and the negative output terminal (OutB) such that the eighth switching element (S8) is turned on and the second power voltage is output through the negative output terminal (OutB). Further, the eighth switching element (S8) is turned on and outputs the first power voltage of the first power supply line (VDD) to the output terminal (Out). At this time, the second storage capacitor (C2) may store the voltage corresponding to the voltage difference between the first power voltage received from the fourth switching element (S4) and the first power voltage received from the eighth switching element (S8). The voltage stored in the second storage capacitor (C2) may be used to compensate for voltage lost in the driving circuit when the first power voltage is output. Since the first switching element (S1) is turned off, the light emitting control driving circuit 300 operates without any change regardless of whether the input signal supplied to the input terminal (In) is at a high level or at a low level.

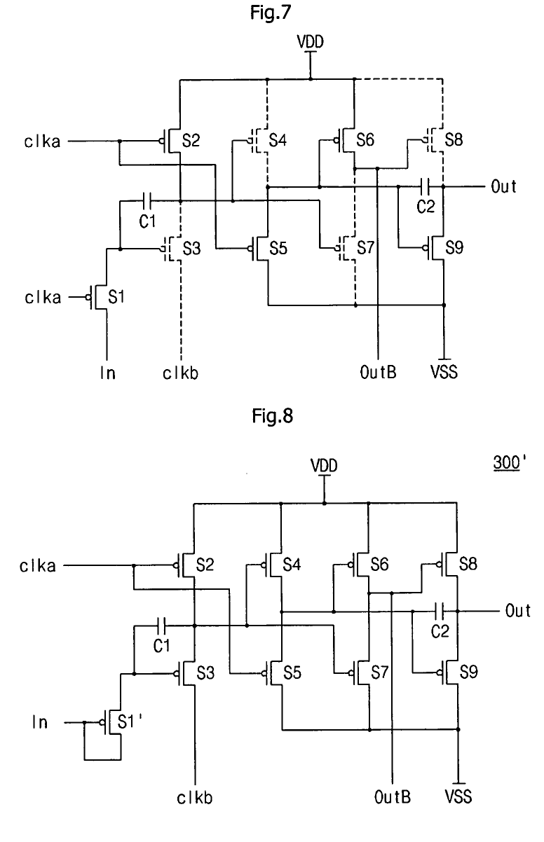

FIG. 7 illustrates a circuit diagram of an operating state of the light emitting control driving circuit 300 shown in FIG. 3 during the third driving period (T53).

During the third driving period (T53), when a clock signal at a low level is supplied to the first clock terminal (clka), the first switching element (S1), the second switching element (S2), and the fifth switching element (S5) are turned on. The first switching element (S1) is turned on and supplies an input signal at a high level transferred from the input terminal (In) to the control electrode of the third switching element (S3) such that the third switching element (S3) is turned off.

Further, during the third driving period (T53), the second switching element (S2) is turned on and applies the first power voltage of the first power supply line (VDD) to the control electrode of the fourth switching element (S4) and the control electrode of the seventh switching element (S7). The fourth switching element (S4) and the seventh switching element (S7) are turned off due to the first power voltage received from the second switching element (S2).

Further, during the third driving period (T53), the fifth switching element (S5) is turned on and applies the second power voltage of the second power supply line (VSS) to the control electrode of the sixth switching element (S6) and the control electrode of the ninth switching element (S9) such that the sixth switching element (S6) and the ninth switching element (S9) are turned on. When the sixth switching element (S6) is turned on, the sixth switching element (S6) applies the first power voltage of the first power supply line (VDD) to the control electrode of the eighth switching element (S8) and the negative output terminal (OutB) such that the eighth switching element (S8) is turned off and the first power voltage is output through the negative output terminal (OutB). Further, the ninth switching element (S9) is turned on and outputs the second power voltage of the second power supply line (VSS) to the output terminal (Out). At this time, the second storage capacitor (C2) stores the voltage corresponding to the voltage difference between the second power voltage received from the fifth switching element (S5) and the second power voltage received from the ninth switching element (S9). The voltage stored in the second storage capacitor (C2) may be used to compensate for voltage lost in the driving circuit 300 when the second power voltage is output.

FIG. 8 illustrates a circuit diagram of another exemplary embodiment of a light emitting control driving circuit 300′ employable by the light emitting control driver shown in FIG. 2.

More particularly, in embodiments of the invention, the light emitting control driving circuit 300′ may be employed by each of the light emitting control driving units (Emission_1, Emission_2, Emission_n/3). In general, only differences between the first exemplary light emitting control driving circuit 300 shown in FIG. 3 and the second exemplary light emitting control driving circuit 300′ shown in FIG. 8 will be described below.

As shown in FIG. 8, the light emitting control driving circuit 300′ may include a first switching element (S1′), the second through ninth switching elements (S2 through S9), the first storage capacitor (C1), and the second storage capacitor (C2).

The first switching element (S1′) may include a first electrode (drain electrode or source electrode) electrically coupled to a control electrode of the third switching element (S3), a second electrode (source electrode or drain electrode) electrically coupled to the input terminal (In), and a control electrode (gate electrode) electrically coupled to the input terminal (In). When a clock signal at a low level is supplied to the control electrode, the first switching element (S1′) is turned on to supply an input signal supplied from the input terminal (In) to the control electrode of the third switching element (S3).

The coupling scheme of the second through ninth switching elements (S2 through S9), the first storage capacitor (C1) and the second storage capacitor (C2) corresponds to the coupling scheme described above with regard to the first exemplary light emitting control driving circuit 300 shown in FIG. 3.

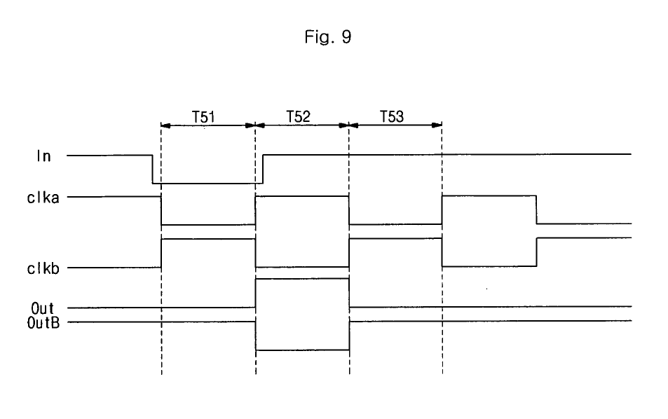

FIG. 9 illustrates a timing diagram of exemplary signals employable for driving the light emitting control driving circuit 300′ shown in FIG. 8.

As shown in FIG. 9, in embodiments of the invention, like the timing diagram of the light emitting control driving circuit 300 shown in FIG. 5, the timing diagram of the exemplary signals employable for driving light emitting control driving circuit 300′ shown in FIG. 8 may include the first driving period (T51), the second driving period (T52), and the third driving period (T53).

During the first driving period (T51), when an input signal at a low level is supplied to the input terminal (In), the first switching element (S1′) is turned on and a clock signal at a low level is supplied to the first clock terminal (clka) such that the second switching element (S2) and the fifth switching element (S5) are turned on. First, the first switching element (S1′) is turned on to supply an input signal at the low level supplied from the input terminal (In) to the control electrode of the third switching element (S3). When the third switching element (S3) receives the input signal at the low level, the third switching element (S3) is turned on and supplies a clock signal at a high level supplied from a second clock terminal (clkb) to the control electrode of the fourth switching element (S4) and the control electrode of the seventh switching element (S7). The fourth switching element (S4) and the seventh switching element (S7), which receive the clock signal at the high level and the first power voltage, are turned off. The first storage capacitor (C1) coupled between the first electrode and the control electrode of the third switching element (S3) may store a voltage corresponding to the voltage difference of the first power voltage received from the second switching element (S2) and the input signal received from the first switching element (S1′).

Next, the fifth switching element (S5) is turned on and applies the second power voltage of the second power supply line (VSS) to the control electrode of the sixth switching element (S6) and the control electrode of the ninth switching element (S9) such that the sixth switching element (S6) and the ninth switching element (S9) are turned on. When the sixth switching element (S6) is turned on, the sixth switching element (S6) applies the first power voltage of the first power supply line (VDD) to the control electrode of the eighth switching element (S8) and the negative output terminal (OutB) such that the eighth switching element (S8) is turned off and the first power voltage is output through the negative output terminal (OutB). Further, the ninth switching element (S9) is turned on and outputs the second power voltage of the second power supply line (VSS) to the output terminal (Out). At this time, the second storage capacitor (C2) may store the voltage corresponding to the voltage difference between the second power voltage received from the fifth switching element (S5) and the second power voltage received from the ninth switching element (S9). The voltage stored in the second storage capacitor (C2) may be used to compensate for voltage lost in the driving circuit 300′ when the second power voltage is output.

During the second driving period (T52), when an input signal at a high level is supplied to the input terminal (In), the first switching element (S1′) is turned off. Further, when the clock signal at a high level is supplied to the first clock terminal (clka), the second switching element (S2) and the fifth switching element (S5) are turned off. At this time, the third switching element (S3) is turned on with the voltage stored in the first storage capacitor (C1) during the first driving period (T51), and supplies the clock signal at a low level supplied from the second clock terminal (clkb) to the control electrode of the fourth switching element (S4) and the control electrode of the seventh switching element (S7). The fourth switching element (S4) and the seventh switching element (S7) receive the clock signal at the low level and are turned on. First, the fourth switching element (S4) is turned on and applies the first power voltage of the first power supply line (VDD) to the control electrode of the sixth switching element (S6) and the control electrode of the ninth switching element (S9) such that the sixth switching element (S6) and the ninth switching element (S9) are turned off.

Next, the seventh switching element (S7) is turned on and applies the second power voltage of the second power supply line (VSS) to the control electrode of the eighth switching element (S8) and the negative output terminal (OutB) such that the eighth switching element (S8) is turned on and the second power voltage is output through the negative output terminal (OutB). Further, the eighth switching element (S8) is turned on and outputs the first power voltage of the first power supply line (VDD) to the output terminal (Out). At this time, the second storage capacitor (C2) stores the voltage corresponding to the voltage difference between the first power voltage received from the fourth switching element (S4) and the first power voltage received from the eighth switching element (S8). The voltage stored in the second storage capacitor (C2) may be used to compensate for the voltage lost in the driving circuit 300′ when the first power voltage is output. Further, since the first switching element (S1′) is turned off, the light emitting control driving circuit 300′ operates without any change regardless of whether the input signal to be supplied to the input terminal (In) is at a high level or at a low level.

During the third driving period (T53), when the input signal at a high level is supplied to the input terminal (In), the first switching element (S1′) is turned off. Further, when the clock signal at a low level is supplied to the first clock terminal (clka), the second switching element (S2) and the fifth switching element (S5) are turned on. When the second switching element (S2) is turned on, the first power voltage of the first power supply line (VDD) is applied to the control electrode of the fourth switching element (S4) and the control electrode of the seventh switching element (S7). The fourth switching element (S4) and the seventh switching element (S7) are turned off due to the first power voltage received from the second switching element (S2). When the fifth switching element (S5) is turned on, the second power voltage of the second power supply line (VSS) is applied to the control electrode of the sixth switching element (S6) and the control electrode of the ninth switching element (S9) such that the sixth switching element (S6) and the ninth switching element (S9) are turned on. When the sixth switching element (S6) is turned on, the sixth switching element (S6) applies the first power voltage of the first power supply line (VDD) to the control electrode of the eighth switching element (S8) and the negative output terminal (OutB) such that the eighth switching element (S8) is turned off and the first power voltage is output through the negative output terminal (OutB). Further, the ninth switching element (S9) is turned on and outputs the second power voltage of the second power supply line (VSS) to the output terminal (Out). At this time, the second storage capacitor (C2) stores the voltage corresponding to the voltage difference between the second power voltage received from the fifth switching element (S5) and the second power voltage received from the ninth switching element (S9). The voltage stored in the second storage capacitor (C2) may be used to compensate for voltage lost in the driving circuit 300′ when the second power voltage is output.

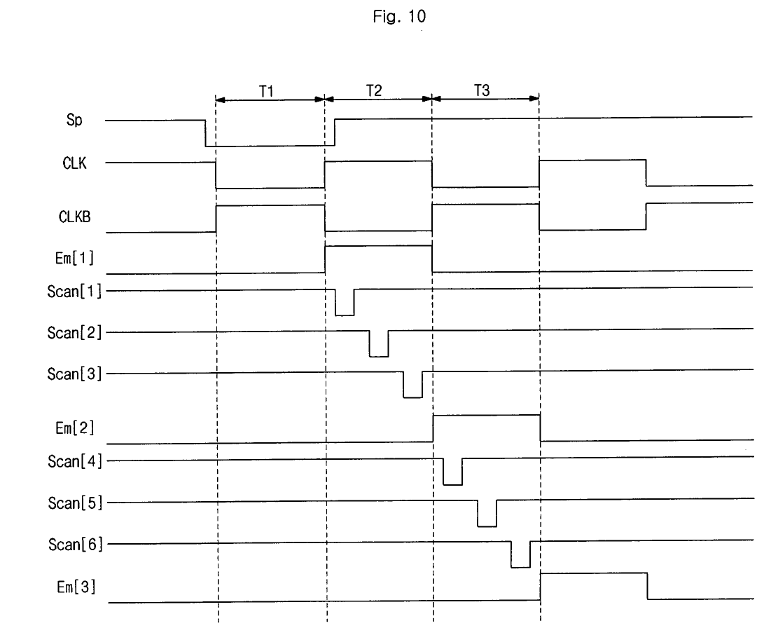

FIG. 10 illustrates a timing diagram of exemplary signals employable for driving the light emitting control driver 130 shown in FIG. 2.

As described above, the light emitting control driver 130 described below may include, e.g., the light emitting control driving circuit 300 and/or 300′ described in FIGS. 3 and 8. That is, operation of the first light emitting control driving unit (Emission_1) to the n/3-th light emitting control driving unit (Emission_n/3) may be the same as described with regard to the timing diagrams illustrated in FIGS. 4 and 9.

As illustrated in FIG. 10, the timing diagram of the light emitting control driver 130 may include a first driving period (T1), a second driving period (T2), a third driving period (T3), a fourth driving period (T4), and a fifth driving period (T5).

As described above, the first light emitting control driving unit (Emission_1) may include the first clock terminal (clka) electrically coupled to the clock line (CLK), the second clock terminal (clkb) electrically coupled to the negative clock line (CLKB), and the input terminal (In) electrically coupled to the initial driving line (Sp).

During the first driving period (T1), the first light emitting control driving unit (Emission_1) may receive a clock signal at a low level, a negative clock signal at a high level, and an initial driving signal at a low level, and may output a first light emitting control signal at a low level to the first light emitting control line (Em[1]) via the output terminal (Out) thereof and a first negative light emitting control signal at a high level to the first negative light emitting control line (EmB[1]) via the negative output terminal (OutB) thereof. Thus, in embodiments of the invention, during the first driving period (T1), the operation of the first light emitting control driving unit (Emission_1) may be the same as the operation of the light emitting control driving circuit 300 and/or 300′ during the first driving period (T51), as described with reference to FIGS. 4 and 9.

During the second driving period (T2), the first light emitting control driving unit (Emission_1) may receive a clock signal at a high level, a negative clock signal at a low level, and an initial driving signal at a high level, and may output a first light emitting control signal at a high level to the first light emitting control line (Em[1]) via the output terminal (Out) terminal thereof and a first negative light emitting control signal at a low level to the first negative light emitting control line (EmB[1]) via the negative output terminal (OutB) thereof. Thus, in embodiments of the invention, during the second driving period (T2), the operation of the first light emitting control driving unit (Emission_1) may be the same as the operation of the light emitting control driving circuit 300, 300′ during the second driving period (T52), as described with reference to FIGS. 4 and 9.

Further, when the first light emitting control signal is output through the first light emitting control line (Em[1]) of the first light emitting control driving unit (Emission_1), each of the first pixel unit (PS_1) to the third pixel unit (PS_3) may be driven. More particularly, each of the first, second and third pixel units (PS_1, PS_2, PS_3) may respectively receive, via the first, second and third scan lines (Scan[1], Scan[2], Scan[3]), a scan signal at a low level.

As described above, the second light emitting control driving unit (Emission_2) may include the first clock terminal (clka) electrically coupled to the negative clock line (CLKB), the second clock terminal (clkb) electrically coupled to the clock line (CLK), and the input terminal (In) electrically coupled to the first negative light emitting control line (EmB[1]).

During the second driving period (T2), the second light emitting control driving unit (Emission_2) may receive the clock signal at the high level, the negative clock signal at the low level, and the first negative light emitting control signal at the low level, and may output a second light emitting control signal at a low level to the second light emitting control line (Em[2]) via the output terminal (Out) thereof, and a second negative light emitting control signal at a high level to the second negative light emitting control line (EmB[2]) via the negative output terminal (OutB) thereof. Thus, in embodiments of the invention, during the second driving period (T2), the operation of the second light emitting control driving unit (Emission_2) may be the same as the operation of the light emitting control driving circuit 300, 300′ during the first driving period (T51), as described with reference to FIGS. 4 and 9.

During the third driving period (T3), the first light emitting control driving unit (Emission_1) may receive a clock signal at a low level, a negative clock signal at a high level, and an initial driving signal at a high level, and may output a first light emitting control signal at a low level to the first light emitting control line (Em[1]) via the output terminal (Out) thereof, and a first negative light emitting control signal at a high level to the first negative light emitting control line (EmB[1]) via the negative output terminal (OutB) thereof. Thus, in embodiments of the invention, during the third driving period (T3), the operation of the first light emitting control driving unit (Emission_1) may be the same as the operation of the light emitting control driving circuit 300, 300′ during the third driving period (T53), as described with reference to FIGS. 4 and 9.

During the third driving period (T3), the second light emitting control driving unit (Emission_2) may receive the clock signal at the low level, the negative clock signal at the high level, and the first negative light emitting control signal at the high level, and may output a second light emitting control signal at a high level to the second light emitting control line (Em[2]) via the output terminal (Out) thereof, and a second negative light emitting control signal at a low level to the second negative light emitting control line (EmB[2]) via the negative output terminal (OutB) thereof. Thus, in embodiments of the invention, during the third driving period (T3), the operation of the second light emitting control driving unit (Emission_2) may be the same as the operation of the light emitting control driving circuit 300, 300′ during the second driving period (T52), as described with reference to FIGS. 4 and 9. Further, when the first light emitting control signal at the high level is output through the second light emitting control line (Em[2]) of the second light emitting control driving unit (Emission_2), each of the fourth, fifth and sixth pixel units (PS_4, PS_5, PS_6) may be driven. More particularly, each of the fourth, fifth and sixth pixel units (PS_4, PS_5, PS_6) may receive a scan signal at a low level from the fourth to sixth scan lines (Scan[4] to Scan[6]).

As discussed above, the third light emitting control driving unit (Emission_3) may include a first clock terminal (clka) electrically coupled to the clock line (CLK), a second clock terminal (clkb) electrically coupled to the negative clock line (CLKB), and an input terminal (In) electrically coupled to the second negative light emitting control line (EmB[2]).

During the third driving period (T3), the third light emitting control driving unit (Emission_3) may receive the clock signal at the low level, the negative clock signal at the high level, and the second negative light emitting control signal at the low level, and may output a third light emitting control signal at a low level to the third light emitting control line (Em[3]) via the output terminal (Out) thereof, and a third negative light emitting control signal at a high level to the third negative light emitting control line (EmB[3]) via the negative output terminal (OutB). Thus, in embodiments of the invention, during the third driving period (T3), the operation of the third light emitting control driving unit (Emission_3) may be the same as the operation of the light emitting control driving circuit 300, 300′ during the first driving period (T51), as described with reference to FIGS. 4 and 9.

During subsequent driving period(s), e.g., (T4), (T5), etc., operations of the respective light emitting control driving units may substantially correspond to the operations of the first light emitting control driving unit to the third light emitting control driving unit (Emission_1 to Emission_3) during the first driving period (T1) to the third driving period (T3). In embodiments, each of the odd-numbered light emitting control driving units may include a first clock terminal (clka) and a second clock terminal (clkb) having the same coupling scheme as the first light emitting control driving unit (Emission_1). Further, each of the odd-numbered light emitting control driving units may include an input terminal (In) electrically coupled to a previous negative light emitting control line to output the light emitting control signal via the light emitting control line via the output terminal (Out) thereof. Each of the even-numbered light emitting control driving units may include a first clock terminal (clka) and a second clock terminal (clkb) having the same coupling scheme as the second light emitting control driving unit (Emission_2). Further, each of the even-numbered light emitting control drivers may include an input terminal (In) electrically coupled to a previous negative light emitting control line to output the light emitting control signal via the light emitting control line via the output terminal (Out) thereof.

As described above, in the organic light emitting display and the driving circuit thereof according to the embodiment of the invention, one light emitting control driving line is electrically coupled to three rows of pixels such that the light emitting control signal may be simultaneously supplied to the three rows of pixels. Therefore, it is possible to reduce the area of the driving circuit, thereby reducing a manufacturing cost and improving the yield.

Further, as described above, in the organic light emitting display and the driving circuit thereof according to the embodiment of the invention, the light emitting control driving circuit is formed by transistors which are the same kind as the pixels. Therefore, it is possible to reduce the manufacturing cost and time, thereby improving the yield.

The above described organic light emitting display and the driving circuit thereof are exemplary embodiments of the invention. The terms are used not to define the meanings thereof or restrict the scope of the present invention described in the claims but to explain embodiments of the present invention. Therefore, it would be appreciated by those skilled in the art that changes might be made in this embodiment without departing from the principles and spirit of the invention, the scope of which is defined in the claims and their equivalents.

What is claimed is:

1. An organic light emitting display, comprising:
a first light emitting control driver electrically coupled to a clock line, a negative clock line, and an initial driving line, and adapted to output a first light emitting control signal via a first light emitting control line;
a first pixel unit electrically coupled to the first light emitting control line;
a second pixel unit electrically coupled to the first light emitting control line; and
a third pixel unit electrically coupled to the first light emitting control line.

2. The organic light emitting display as claimed in claim 1, further comprising a panel including first to m-th data lines, wherein:
the first pixel unit includes first row pixels electrically coupled to a first scan driving line and the first to m-th data lines;
the second pixel unit includes second row pixels electrically coupled to a second scan driving line and the first to m-th data lines; and
the third pixel unit includes third row pixels electrically coupled to a third scan driving line and the first to m-th data lines.

3. The organic light emitting display as claimed in claim 2, wherein each of the first to third pixel units respectively receives the first light emitting control signal to emit light simultaneously.

4. The organic light emitting display as claimed in claim 1,
wherein the first light emitting control driver includes a first clock terminal electrically coupled to the clock line, a second clock terminal electrically coupled to the negative clock line, an input terminal electrically coupled to the initial driving line, an output terminal electrically coupled to the first light emitting control line and adapted to output to first light emitting control signal, and a negative output terminal electrically coupled to a first negative light emitting control line and adapted to output a first negative light emitting control signal.

5. The organic light emitting display as claimed in claim 4, further comprising a second light emitting control driver including an input terminal, wherein the output terminal of the first light emitting control driver is electrically coupled to the input terminal of the second light emitting control driver.

6. The organic light emitting display as claimed in claim 1, wherein the first light emitting control driver includes:
a first switching element electrically coupled between the initial driving line and a first power voltage line;
a second switching element including a control electrode electrically coupled to the clock line and being electrically coupled between the first switching element and the first power voltage line;
a third switching element including a control electrode electrically coupled between the first switching element and the second switching element and being electrically coupled between the second switching element and the negative clock line;
a fourth switching element including a control electrode electrically coupled between the second switching element and the third switching element and being electrically coupled between the first power voltage line and a second power voltage line;
a fifth switching element including a control electrode electrically coupled to the clock line and being electrically coupled between the fourth switching element and the second power voltage line;
a sixth switching element including a control electrode electrically coupled between the fourth switching element and the fifth switching element and being electrically coupled between the first power voltage line and the second power voltage line;
a seventh switching element including a control electrode electrically coupled between the second switching element and the third switching element and being electrically coupled between the sixth switching element and the second power voltage line;
an eighth switching element including a control electrode electrically coupled between the sixth switching element and the seventh switching element and being electrically coupled between the first power voltage line and the second power voltage line; and
a ninth switching element including a control electrode electrically coupled between the fourth switching element and the fifth switching element and being electrically coupled between the eighth switching element and the second power voltage line.

7. The organic light emitting display as claimed in claim 6, wherein: the first switching element includes a control electrode electrically coupled to the clock line, a first electrode electrically coupled to the control electrode of the third switching element, and a second electrode electrically coupled to the initial driving line.

8. The organic light emitting display as claimed in claim 6, wherein the first switching element includes a control electrode electrically coupled to the initial driving line, a first electrode electrically coupled to the control electrode of the third switching element, and a second electrode electrically coupled to the initial driving line.

9. The organic light emitting display as claimed in claim 6, wherein the second switching element includes a first electrode electrically coupled to the first power voltage line, and a second electrode electrically coupled between a first electrode of the third switching element and the control electrode of the fourth switching element.

10. The organic light emitting display as claimed in claim 6, wherein the third switching element includes a first electrode electrically coupled between the control electrodes of the fourth and seventh switching elements, and a second electrode electrically coupled to the negative clock line.

11. The organic light emitting display as claimed in claim 6, wherein the fourth switching element includes a first electrode electrically coupled to the first power voltage line, and a second electrode electrically coupled between a first electrode of the fifth switching element and the control electrode of the sixth switching element.

12. The organic light emitting display as claimed in claim 6, wherein the fifth switching element includes a first electrode electrically coupled between the control electrodes of the sixth and ninth switching elements, and a second electrode electrically coupled to the second power voltage line.

13. The organic light emitting display as claimed in claim 6, wherein the sixth switching element includes a first electrode electrically coupled to the first power voltage line, and a second electrode electrically coupled between the first electrode of the seventh switching element, and the control electrode of the eighth switching element.

14. The organic light emitting display as claimed in claim 6, wherein the seventh switching element includes a first electrode electrically coupled between the control electrode of the eighth switching element and a first negative light emitting control line, and a second electrode electrically coupled to the second power voltage line.

15. The organic light emitting display as claimed in claim 6, wherein the eighth switching element includes a first electrode electrically coupled to the first power voltage line, and a second electrode electrically coupled to the first light emitting control line.

16. The organic light emitting display as claimed in claim 6, wherein the ninth switching element includes a first electrode electrically coupled to the first light emitting control line, and a second electrode electrically coupled to the second power voltage line.

17. The organic light emitting display as claimed in claim 6, further comprising a first storage capacitor including a first electrode electrically coupled to the control electrode of the third switching element and a second electrode electrically coupled between the second switching element and the third switching element.

18. The organic light emitting display as claimed in claim 6, further comprising a second storage capacitor including a first electrode electrically coupled between the control electrode of the ninth switching element and the control electrode of the sixth switching element, and a second electrode electrically coupled between the eighth switching element, the ninth switching element, and the first light emitting control line.

19. A driving circuit, comprising:
a plurality of light emitting control drivers,
wherein each of the light emitting control driver includes:
an input terminal electrically coupled to an initial driving line or a negative light emitting control line of a previous light emitting control driver;
a first clock terminal electrically coupled to a clock line;
a second clock terminal electrically coupled to a negative clock line in which a phase thereof is inverted with respect to that of the clock line;
an output terminal; and
a negative output terminal,
wherein the light emitting control driver is adapted to receive an input signal from the input terminal, a clock signal from the first clock terminal, and a negative clock signal from the second clock terminal and to generate an output signal and a negative output signal to be respectively supplied to the output terminal and the negative output terminal.

20. The driving circuit as claimed in claim 19,
wherein each of the light emitting control driver includes:
a first switching element electrically coupled between the input terminal and a first power voltage line;
a second switching element including a control electrode electrically coupled to the first clock terminal and being electrically coupled between the first switching element and the first power voltage line;
a third switching element including a control electrode electrically coupled between the first switching element and the second switching element and being electrically coupled between the second switching element and the second clock terminal;
a fourth switching element including a control electrode electrically coupled between the second switching element and the third switching element and being electrically coupled between the first power voltage line and a second power voltage line;
a fifth switching element including a control electrode electrically coupled to the first clock terminal and being electrically coupled between the fourth switching element and the second power voltage line;
a sixth switching element having a control electrode electrically coupled between the fourth switching element and the fifth switching element and being electrically coupled between the first power voltage line and the second power voltage line;
a seventh switching element including a control electrode electrically coupled between the second switching element and the third switching element and being electrically coupled between the sixth switching element and the second power voltage line;
an eighth switching element including a control electrode electrically coupled between the sixth switching element and the seventh switching element and being electrically coupled between the first power voltage line and the second power voltage line; and
a ninth switching element including a control electrode electrically coupled between the fourth switching element and the fifth switching element and being electrically coupled between the eighth switching element and the second power voltage line.

21. The driving circuit as claimed in claim 20, wherein a first light emitting control driver of the light emitting control driver includes a first clock terminal electrically coupled to the clock line, a second clock terminal electrically coupled to the negative clock line, an input terminal electrically coupled to the initial driving line, an output terminal electrically coupled to the first light emitting control line to output a first light emitting control signal, and a negative output terminal electrically coupled to the first negative light emitting control line to output a first negative light emitting control signal.

22. The driving circuit as claimed in claim 20, wherein even-numbered ones of the plurality of light emitting control drivers each include a first clock terminal electrically coupled to the negative clock line, a second clock terminal electrically coupled to the clock line, an input terminal electrically coupled to the negative light emitting control line of a previous light emitting control driver, an output terminal electrically coupled to an even-numbered light emitting control line to output a respective light emitting control signal, and a negative output terminal electrically coupled to an even-numbered negative light emitting control line to output a respective negative light emitting control signal.

23. The driving circuit as claimed in claim 20, wherein odd-numbered ones of the plurality of light emitting control drivers include a first clock terminal electrically coupled to the clock line, a second clock terminal electrically coupled to the negative clock line, an input terminal electrically coupled to one of the initial driving line or the negative light emitting control line of a previous light emitting control driver, an output terminal electrically coupled to an odd-numbered light emitting control line to output a respective light emitting control signal, and a negative output terminal electrically coupled to an odd-numbered negative light emitting control line to output a respective negative light emitting control signal.

24. The driving circuit as claimed in claim 20, wherein the first switching element includes a control electrode electrically coupled to the first clock terminal, a first electrode electrically coupled to the control electrode of the third switching element, and a second electrode electrically coupled to the input terminal.

25. The driving circuit as claimed in claim 20, wherein the first switching element includes a control electrode electrically coupled to the input terminal, a first electrode electrically coupled to the control electrode of the third switching element, and a second electrode electrically coupled to the input terminal.

26. The driving circuit as claimed in claim 20, wherein the second switching element includes a first electrode electrically coupled to the first power voltage line, and a second electrode electrically coupled between a first electrode of the third switching element and the control electrode of the fourth switching element.

27. The driving circuit as claimed in claim 20, wherein the third switching element includes a first electrode electrically coupled between the control electrode of the fourth switching element and the control electrode of the seventh switching element, and a second electrode electrically coupled to the second clock terminal.

28. The driving circuit as claimed in claim 20, wherein the fourth switching element includes a first electrode electrically coupled to the first power voltage line, and a second electrode electrically coupled between a first electrode of the fifth switching element and the control electrode of the sixth switching element.

29. The driving circuit as claimed in claim 20, wherein the fifth switching element includes a first electrode electrically coupled between the control electrode of the sixth switching element and the control electrode of the ninth switching element, and a second electrode electrically coupled to the second power voltage line.

30. The driving circuit as claimed in claim 20, wherein the sixth switching element includes a first electrode electrically coupled to the first power voltage line, and a second electrode electrically coupled between the first electrode of the seventh switching element and the control electrode of the eighth switching element.

31. The driving circuit as claimed in claim 20, wherein the seventh switching element includes a first electrode electrically coupled between the control electrode of the eighth switching element and a first negative light emitting control line, and a second electrode electrically coupled to the second power voltage line.

32. The driving circuit as claimed in claim 20, wherein the eighth switching element includes a first electrode electrically coupled to the first power voltage line, and a second electrode electrically coupled to a first light emitting control line.

33. The driving circuit as claimed in claim 20, wherein the ninth switching element includes a first electrode electrically coupled to the first light emitting control line, and a second electrode electrically coupled to the second power voltage line.

34. The driving circuit as claimed in claim 20, further comprising:
a first storage capacitor including a first electrode electrically coupled to the control electrode of the third switching element and a second electrode electrically coupled between the second switching element and the third switching element.

35. The driving circuit as claimed in claim 20, further comprising:
a second storage capacitor including a first electrode electrically coupled between the control electrode of the ninth switching element and the control electrode of sixth switching element, and a second electrode electrically coupled among the eighth switching element, the ninth switching element, and the first light emitting control line.

36. The driving circuit as claimed in claim 20, wherein the first, second, third, fourth, fifth, sixth, seventh, eighth and ninth switching elements are a same transistor type.

37. An organic light emitting display comprising the driving circuit as claimed in claim 19.
